(19) United States
(12) Patent Application Publication
(10) Pub. No.: US 2020/0198112 A1
(43) Pub. Date: Jun. 25, 2020

(54) AUXILIARY GRIP OF HAND-HELD POWER TOOL

(71) Applicant: STORM PNEUMATIC TOOL CO., LTD., Taichung City (TW)

(72) Inventor: Yung Yung SUN, Taichung City (TW)

(21) Appl. No.: 16/227,602

(22) Filed: Dec. 20, 2018

(51) Int. Cl. B25F 5/00

(52) U.S. Cl. CPC B25F 5/006

(57) ABSTRACT

An auxiliary grip of a hand-held power tool includes a rod body, a connecting member, and a covering layer made of an elastic material. An end portion of the rod body has a first coupling portion. Two ends of the connecting member have a connecting section and a second coupling portion, respectively. The second coupling portion of the connecting member is coupled with the first coupling portion of the rod body so that the rod body can be swayed relative to the connecting member. The covering layer covers the rod body and a part of the connecting member. The connecting section of the connecting member is connected to a power tool. When the power tool causes the auxiliary grip to vibrate due to its mechanical operation, the rod body can be swayed relative to the connecting member to reduce the vibration during the grip.

### FIELD OF THE INVENTION

The present invention relates to an auxiliary grip, and more particularly to an auxiliary grip of a hand-held power tool.

### BACKGROUND OF THE INVENTION

There are many hand-held power tools on the market, such as electric or pneumatic hammer drills, drills, etc. When the power tool is operated, it will generate vibrations inevitably. As a result, the user cannot operate the tool accurately, which affects the work efficiency. In order to solve the above problems, the power tool may be provided with an auxiliary grip. The auxiliary grip is mainly composed of a rod body and a rubber layer covering the outside of the rod body and having a buffering effect. Thus, the vibration generated by the power tool can be redued when the user grips the rubber layer on the rod body.

However, althouth such a conventional auxiliary grip can be designed to reduce the vibration generated by the power tool during operation through the design of the rod body and the rubber layer, the manner that the auxiliary grip reduces the vibration depends on the material property of the rubber layer, so the effect to reduce the vibration is very limited.

Accordingly, the inventor of the present invention has devoted himself based on his many years of practical experiences to solve these problems.

### SUMMARY OF THE INVENTION

The present invention is to provide an auxiliary grip of a hand-held power tool. Through the design that a rod body can be swayed relative to a connecting member, the vibration can be reduced effectively, thereby improving the operability greatly when the user operates the power tool.

In order to achieve the aforesaid object, an auxiliary grip of a hand-held power tool is provided. The auxiliary grip comprises a rod body, a connecting member, and a covering layer.

The rod body has an end portion. The end portion has a first coupling portion. The end portion is provided with a first plate member.

The connecting member has a first end and a second end. The first end has a connecting section. The second end has a second coupling portion in cooperation with the first coupling portion. The second coupling portion of the connecting member is coupled with the first coupling portion of the rod body so that the rod body can be swayed relative to the connecting member. A first gap is defined between the first coupling portion and the second coupling portion. A second gap is defined between the end portion of the rod body and the second end of the connecting member. The second end is provided with an second plate member that is arranged at a distance from the first plate member.

The covering layer is made of an elastic material. The covering layer covers the rod body, a part of the connecting member, the first plate member and the second plate member and fills the first gap and the second gap. The connecting section of the connecting member is exposed outside the covering layer. The covering layer includes an enlarged portion corresponding in position to the first plate member and the second plate member and a grip portion corresponding in position to the rod body.

Preferably, the end portion of the rod body is formed with a first shoulder. The first plate member is fitted on the end portion and leans against the first shoulder. The second end of the connecting member is formed with a second shoulder. The second plate member is fitted on the second end and leans against the second shoulder. The first plate member is spaced apart from the second plate member.

Preferably, the first coupling portion is a protruding block. The second coupling portion is a trough corresponding to the protruding block. The trough is configured to receive the the protruding block therein.

Preferably, the protruding block has a spherical shape, and the trough has a polygonal vertical section.

Preferably, the covering layer fills the first gap and covers a large part of the protruding block so that a buffer layer is formed between the protruding block and the trough.

Preferably, the first plate member and the second plate member are respectively provided with a plurality of through holes arranged in an annular shape. The covering layer fills the through holes and covers the first plate member and the second plate member to form the enlarged portion.

Preferably, the covering layer fills the second gap between the second end of the connecting member and the end portion of the rod body to form a compression area.

The above objects and advantages of the present invention will be readily understood from the following detailed description of the embodiments of the invention.

### BRIEF DESCRIPTION OF THE DRAWINGS

FIG. 1 is a perspective view of the present invention;

FIG. 2 is an exploded view of the present invention, without the covering layer;

FIG. 3 is a sectional view of the present invention;

FIG. 4 is a partially enlarged view of FIG. 3; and

FIG. 5 is a schematic view of the present invention when in use, showing that the rod body is swayed relative to the connecting member.

### DETAILED DESCRIPTION OF THE PREFERRED EMBODIMENTS

Embodiments of the present invention will now be described, by way of example only, with reference to the accompanying drawings.

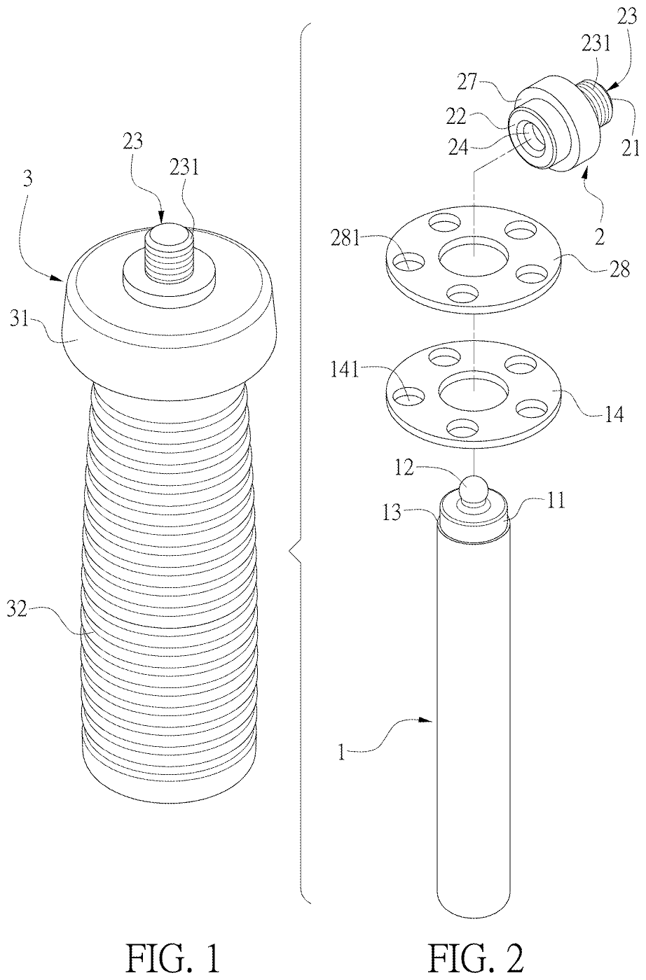

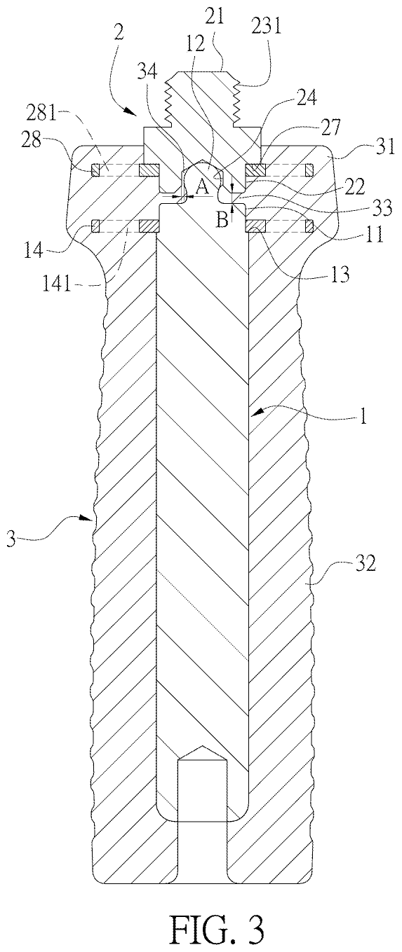

As shown in FIGS. 1 to 3, an auxiliary grip of a hand-held power tool provided by the present invention comprises a rod body 1, a connecting member 2, and a covering layer 3.

The rod body 1 has an end portion 11. The end portion 11 has a first coupling portion. In this embodiment, the first coupling portion is a protruding block 12 extending axially from the end portion 11 and having a spherical shape. The end portion 11 has a first shoulder 13. An annular first plate member 14 is sleeved on the end portion 11 and leans against the first shoulder 13, thereby facilitating the subsequent processing operations.

The connecting member 2 has a first end 21 and a second end 22. The first end 21 has a connecting section 23 that is connected to a power tool (not shown in the figures). The second end 22 has a second coupling portion in cooperation with the first coupling portion. In this embodiment, the second coupling portion is a trough 24 having a polygonal vertical section. The trough 24 of the connecting member 2 is coupled with the protruding block 12 of the rod body 1, so that the rod body 1 can be swayed relative to the connecting member 2. A first gap A is defined between the protruding block 12 and the trough 24. A second gap B is defined between the end portion 11 and the second end 22 of the connecting member 2. The second end 22 is formed with a second shoulder 27. An annular second plate member 28 is sleeved on the second end 22 and leans against the second shoulder 27. The first plate member 14 is arranged at a distance from the second plate member 28.

The covering layer 3 is made of an elastic rubber material in the embodiment. The covering layer 3 covers the rod body 1, a part of the connecting member 2, the first plate member 14 and the second plate member 28, and the covering layer 3 fills the first gap A and the second gap B, so that the rod body 1 and the connecting member 2 are positioned relative to each other. The rod body 1 can be slightly swayed relative to the connecting member 2 when subjected to an external force. In this embodiment, the connecting section 23 of the connecting member 2 is exposed outside the covering layer 3. In this embodiment, through the design of the trough 24 having a polygonal vertical section, the covering layer 3 enables the first gap A between the trough 24 and the protruding block 12 to form a buffer layer 34. Therefore, when the rod body 1 is swayed, the protruding block 12 can reduce the direct contact with the trough 24 through the buffer layer 34, thereby providing a better cushioning effect.

The covering layer 3 includes an enlarged portion 31 corresponding in position of the first plate member 14 and the second plate member 28 and a grip portion 32 corresponding in position to the rod body 1 for the hand to grip thereon. The diameter of the enlarged portion 31 is greater than the diameter of the grip portion 32. In the embodiment, the first plate member 14 and the second plate member 28 are respectively provided with a plurality of through holes 141, 281 arranged in an annular shape. The covering layer 3 fills the through holes 141, 281 and covers the first plate member 14 and the second plate member 28, thereby allowing the covering layer 3 to cover the first plate member 14 and the second plate member 28 more firmly. Due to the enlarged portion 31, the first plate member 14 and the second plate member 28, the enlarged portion 31 is not too soft to be manipulated or broken.

In this embodiment, the connecting section 23 of the connecting member 2 is formed with an outer screw thread 231.

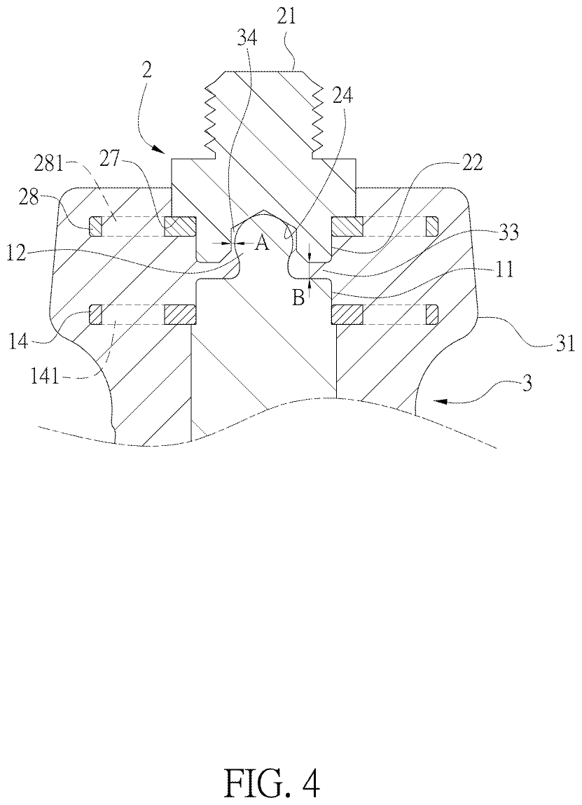

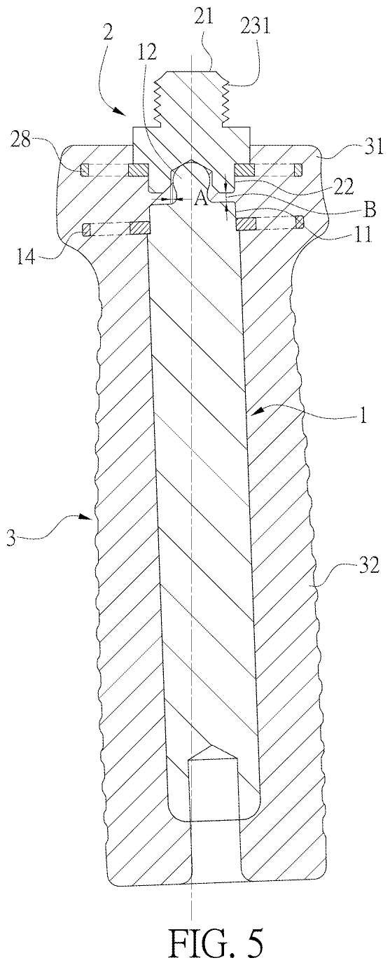

In addition, as shown in FIGS. 4 and 5, the covering layer 3 fills the second gap B between the second end 22 of the connecting member 2 and the end portion 11 of the rod body 1 to form a compression area 33. When the rod body 1 is swayed relative to the connecting member 2, the compression area 33 can elastically leans against the end portion 11 of the rod body 1 and the second end 22 of the connecting member 2 through the characteristics of the material thereof, thereby reduing the amplitude when the rod body 1 is swayed relative to the connecting member 2.

With the above structure, when the power tool causes the auxiliary grip to vibrate due to its mechanical operation, through the design that the protruding block 12 of the rod body 1 is coupled with the trough 24 of the connecting member 2, the auxiliary grip can make the rod body 1 sway relative to the connecting member 2 fixed on the power tool, thereby reducing the vibration effectively when the user grips the auxiliary grip.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. An auxiliary grip of a hand-held power tool, comprising:
a rod body, having an end portion, the end portion having a first coupling portion, the end portion being provided with a first plate member;
a connecting member, having a first end and a second end, the first end having a connecting section, the second end having a second coupling portion in cooperation with the first coupling portion, the second coupling portion of the connecting member being coupled with the first coupling portion of the rod body so that the rod body can be swayed relative to the connecting member, a first gap being defined between the first coupling portion and the second coupling portion, a second gap being defined between the end portion of the rod body and the second end of the connecting member; the second end being provided with an second plate member that is arranged at a distance from the first plate member;
a covering layer, made of an elastic material, the covering layer covering the rod body, a part of the connecting member, the first plate member and the second plate member and filling the first gap and the second gap, the connecting section of the connecting member being exposed outside the covering layer; the covering layer including an enlarged portion corresponding in position to the first plate member and the second plate member and a grip portion corresponding in position to the rod body.

2. The auxiliary grip of the hand-held power tool as claimed in claim 1, wherein the end portion of the rod body is formed with a first shoulder, the first plate member is fitted on the end portion and leans against the first shoulder; the second end of the connecting member is formed with a second shoulder, the second plate member is fitted on the second end and leans against the second shoulder, and the first plate member is spaced apart from the second plate member.

3. The auxiliary grip of the hand-held power tool as claimed in claim 1, wherein the first coupling portion is a protruding block, the second coupling portion is a trough corresponding to the protruding block, and the trough is configured to receive the the protruding block therein.

4. The auxiliary grip of the hand-held power tool as claimed in claim 3, wherein the protruding block has a spherical shape, and the trough has a polygonal vertical section.

5. The auxiliary grip of the hand-held power tool as claimed in claim 3, wherein the covering layer fills the first gap and covers a large part of the protruding block so that a buffer layer is formed between the protruding block and the trough.

6. The auxiliary grip of the hand-held power tool as claimed in claim 1, wherein the first plate member and the second plate member are respectively provided with a plurality of through holes arranged in an annular shape, the covering layer fills the through holes and covers the first plate member and the second plate member to form the enlarged portion.

7. The auxiliary grip of the hand-held power tool as claimed in claim 1, wherein the covering layer fills the second gap between the second end of the connecting member and the end portion of the rod body to form a compression area.
